(19) United States
(12) Patent Application Publication
(10) Pub. No.: US 2003/0002109 A1
(43) Pub. Date: Jan. 2, 2003

(54) Eye safety shutdown

(76) Inventors: Jim Hochberg, Bedford, NH (US); Rien Gahlsdorf, Nashua, NH (US); Tim Ireland, Amherst, NH (US); Ted Wyman, Mount Vernon, NH (US)

Correspondence Address: MORGAN & FINNEGAN, L.L.P., 345 Park Avenue, New York, NY, 10154-0053, US

(21) Appl. No.: 09/897,165

(22) Filed: Jun. 29, 2001

(51) Int. Cl. H04B 10/08; H04B 10/00

(52) U.S. Cl. 359/152; 359/110

(57) ABSTRACT

A method of minimizing a risk of damage to human tissue, caused by an exposure to an amount of laser radiation in excess of a maximum permissible exposure level performed in an optical transceiver having at least two photodetectors and at least two laser transmitters. The method involves monitoring at least one of the photodetectors for receipt of an optical signal; determining if a received optical signal satisfies at least one expected activity criterion; and, if the received optical signal does not satisfy the at least one expected activity criterion, determining that an eye safety fault condition exists and causing a shut down of at least one of the at least two laser transmitters. An optical transceiver with multiple optical devices includes a transmit channel; a receiver channel; an eye safety channel; and a controller, coupled to the transmit channel and eye safety channel. The controller is configured to receive information based upon a monitoring of the eye safety channel and shut down the transmit channel when the information indicates that an eye safety fault has occurred.

### FIELD OF THE INVENTION

This invention relates to eye safety and, more particularly, to eye safety from exposure to the output of a laser.

### BACKGROUND OF THE INVENTION

In the recent past, lasers were typically only found in laboratories and/or specialized medical treatment facilities. Access to such lasers was strictly controlled and, even then, safety was a significant concern.

With the proliferation of low power laser devices such as supermarket/barcode scanners, CD players, optical disk drives and laser pointers, lasers have moved from a controlled setting to one that is largely unregulated in terms of safety during day to day use. In most cases, the above laser devices, represent a small to non-existent danger either because of their packaging (which limits access at all), their low power, or limitations on possession and/or use under local laws.

For many reasons, the use of fiber optics for communication, whether among devices in a computer network or telecommunications devices, has caused the number of devices present in homes and offices having lasers to expand dramatically.

As a result, people untrained in laser safety have access to laser devices like never before—pushing laser safety issues to the forefront. Specifically, the largest group of people at risk are Information Technology (IT) personnel who may routinely have access to laser light carrying optical fibers. Such persons may not know or realize that light entering the eye from a collimated beam is concentrated by a factor of 100,000 times between the cornea and retina. Thus, a relatively low power density laser beam emitted from an optical fiber can result in more than enough power density in the eye to cause retinal damage.

In order to minimize the hazards associated with exposure to laser beams, a number of entities have promulgated standards for laser safety, for example, the American National Standards Institute's ANSI Z136, Occupational Safety and Health Administration (OSHA) standards, and Center for Devices and Radiological Health (CDRH) regulations. However, for the types of lasers used in telecommunications and computer networks, those standards do not generally prescribe anything other than requiring that different warning labels, such as shown in FIGS. 1A-1F, be affixed to a device, depending upon the particular class of laser being used.

Typically, optical communications devices interconnect to each other via optical fibers coupled to the devices by some form of connector 200, for example, an MT, MTP, MPO, or MPX style connector to name a few. FIG. 2 is an example of an enlarged portion of a fiber optic connector 200. The connector has an outer housing 210, encompassing some component 220 for example, a ferrule that holds one or more optical fibers 230, 240.

Depending upon the particular usage, the same end of both fibers 230, 240 may be ultimately connected to a dedicated transmitter or a dedicated receiver. Alternatively, one end of one of the fibers 230 may be ultimately connected to a transmitter, whereas the same end of the other fiber 240 may be ultimately connected to a receiver. In some cases, such a connector 200 may be somewhere along a length of optical cable, for example as shown in FIG. 3, where two optical cables, fiber bundles or fiber ribbons 300, 305 are connected via a connector 200 having a male portion 245 and a female portion 250.

As noted above, one of the problems associated with an optical communications device is that of eye safety. If an optical fiber is removed from the device (for example by disconnecting the MT, MTP, MPO, or MPX style connector) during operation, a laser may still be transmitting over that fiber. At certain frequencies, if the fiber is pointed at a human eye, the laser can cause minimal to severe damage to the eye. Moreover, a given connector may contain more than one concurrently usable fiber, for example, a 1×12 array of fibers. In that case, the aggregate power density coming from the connector could be higher (e.g. up to 12 times the power density when all the fibers are in use in a common direction and the outputs are all in phase) thereby posing an eye safety risk even if each individual laser's power is well below what is considered safe.

In the case of optical networking and/or telecommunications, of the fiber optics products which do implement some kind of eye safety, it is typically done by making sure the power density of the individual lasers is low enough so that the aggregate power density is around or below the safe range. Unfortunately, doing so limits the distance over which information can be transmitted and, where great distances must be traversed, necessitates the addition of additional equipment to boost or relay the optical signal thereby increasing cost. Moreover, for the above application, there is a minimum required power density for the lasers to be usable at all. Thus, if the safety approach of lowering individual laser power is used, then the minimum necessary power density dictates the maximum number of lasers that can be employed before the aggregate power exceeds the eye safety limit and hence, the maximum number of lasers that can concurrently be used.

Mechanical interlocks or shutters, to the extent they may be used, provide some measure of protection from exposure to laser light. However, mechanical interlocks are typically inconvenient, and are often easy to bypass or defeat. Moreover, adding interlocks and/or shutters increase manufacturing cost, compexity, or may be unsuitable for some applications. Moreover, neither a mechanical interlock nor a shutter provide protection when an opening occurs at a point other than at the interlock or shutter trigger points, for example, when one or more fibers are inadvertently cut along their length but part containing the interlock or shutter trigger remains intact and/or connected.

Mechanical interlocks and shutters also typically work on the “complete disable” principle, i.e. if a breach occurs, the system shuts down. While this may be acceptable for some applications it may be wholly unacceptable for others, for example, an arrangement that takes down an entire computer network, for example, because an optical cable between two out of a number of devices was disconnected will almost always be unacceptable.

Thus there is a need to be able to reduce or eliminate the risk of eye damage, due to exposure to the beam from a laser, when a breach in the optical path occurs due to opening or removal of a connector. Moreover, in some cases, there is a further need to be able to eliminate such risk when the exposure is due to the optical path having been breached at some location other than the connector or shutter point.

### SUMMARY OF THE INVENTION

We have devised a way to provide for optical device eye safety that does not require a reduction in laser power, irrespective of whether three, three hundred, three thousand or more lasers are concurrently used. We have further devised a way to provide eye safety, for some implementations, that works even if a fiber cable, bundle or ribbon is cut anywhere along its length.

One aspect of the invention relates to a method of minimizing a risk of damage to human tissue, caused by an exposure to an amount of laser radiation in excess of a maximum permissible exposure level performed in an optical transceiver having at least two photodetectors and at least two laser transmitters. The method involves monitoring at least one of the photodetectors for receipt of an optical data signal; determining if a received optical data signal satisfies at least one expected activity criterion; and, if the received optical data signal does not satisfy the at least one expected activity criterion, determining that an eye safety fault condition exists and causing a shut down of at least one of the at least two laser transmitters.

Another aspect of the invention involves an optical transceiver with multiple optical devices includes a transmit channel; a receiver channel; an eye safety channel; and a controller, coupled to the transmit channel and eye safety channel. The controller is configured to receive information based upon a monitoring of the eye safety channel and shut down the transmit channel when the information indicates that an eye safety fault has occurred.

These and other aspects described herein, or resulting from the using teachings contained herein, provide advantages and benefits over the prior art.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIGS. 1A through 1F are example warning labels for use on various classes of laser devices;

FIG. 2 is an example of an enlarged portion of a prior art fiber optic connector;

FIG. 3 is an optical cable having a connector somewhere along its length;

FIG. 4 is a simplified functional representation of a transceiver suitable for configuring to operate according to the principles of the invention;

FIG. 5 is a simplified representation of a one-dimensional array of optical devices;

FIG. 6 is a simplified representation of a two dimensional array of optical devices;

FIG. 7 is a 6×12 array of optical devices in a transceiver employing the invention; and

FIG. 8 illustrates a 96 device array having 64 transmitters (paired as groups of two) for redundancy, and 32 receivers.

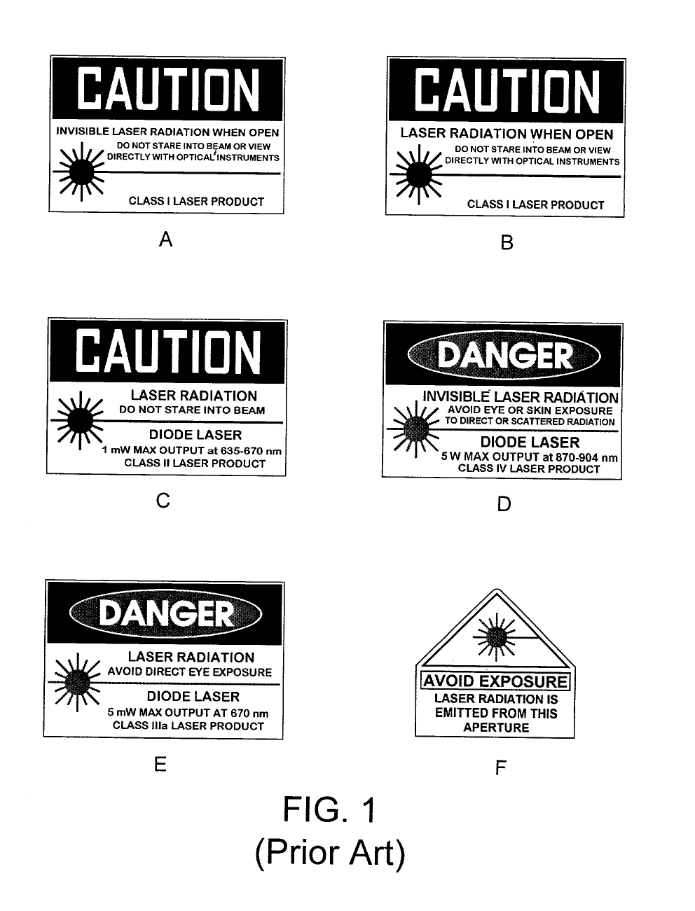

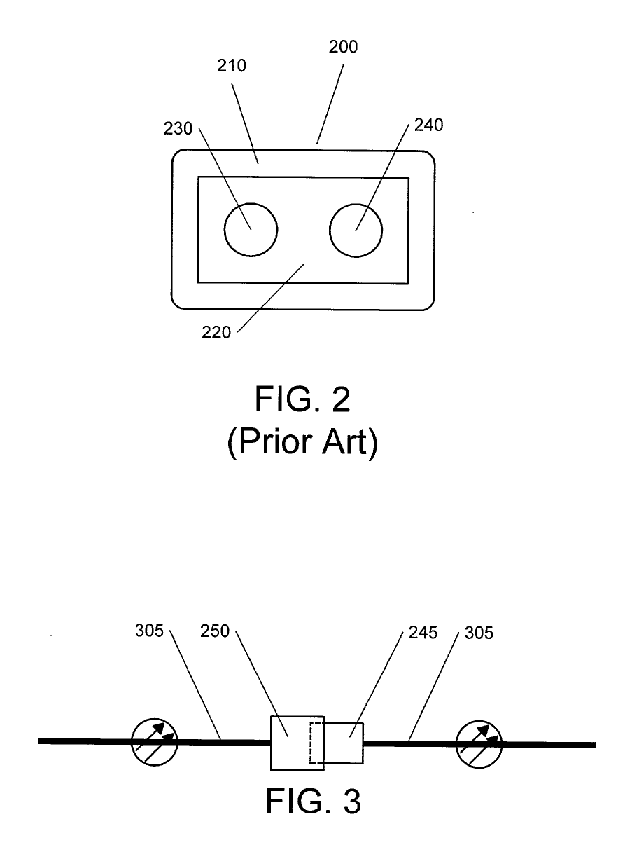

### DETAILED DESCRIPTION

By way of overview, we use a detection of receiver activity to control transmit lasers. As will be explained in greater detail below, in some implementations, i.e. those where the devices are transceivers, one or more receivers in the transceiver are used to control the lasers in the same transceiver. In other implementations, typically where there is a matched pair of similar type transceivers, receivers on one transceiver can control the lasers on the complementary transceiver. In still other implementations a receiver can provide a measure of eye safety even if it is not part of a transceiver by issuing an eye safety fault signal that can be used to initiate a transmitter shut down.

In still other variants, devices can be grouped so that, if one or more fibers associated with a particular group are breached, any remaining groups can continue to run at full power. In yet other variants, the groups can be controlled so that when one or more fibers in the group are breached, only some of the lasers in the group will be shut down, thereby allowing at least some of the channels in the group to continue to be used.

As described herein, the invention is broadly applicable to systems involving devices employing an array of transmitters and an array of receivers respectively containing two or more lasers or detectors. Moreover, those devices can be arrayed in any positional arrangement, for example, three redundant lasers may be arranged in a triangular arrangement, and groups of devices may be arrayed in a different arrangement, for example, a linear or two-dimensional array of the individual triangular groups, although it is contemplated that, such use will more likely involve linear, square or rectangular arranged arrays of, from about six lasers to dozens, hundreds or even thousands.

Although arrangements involving arrays with small numbers of lasers (i.e. between two and a dozen) can employ the invention, in some variants (i.e. those employing dedicated eye safety channels), doing so potentially reduces the amount of overall usable capacity. Thus, a loss in capacity resulting from use with arrays of less than a dozen lasers introduces disadvantages which may need to be weighed against the advantages of such use in the particular case. In fact, as will be evident from the description herein, some advantages derived from the invention become more significant as the number of lasers increase and even promote the use of more lasers. This is because, as the number of overall channels increases, the number of eye safety related channels can become a smaller part of the whole on a percentage basis (i.e. where a single eye safety channel can be used for larger and larger arrays it becomes, for example, 1 out of six (16.7%), 1 out of 12 (8.3%), 1 out of 48 (2.1%), 1 out of 120 (0.83%), etc.). It is specifically contemplated that particular implementations employing the invention will typically involve devices having 6, 12, 24, 36, 48, 60, 72, 84, 96, 108, 120, 132 or 144 lasers, or multiples thereof, although as noted above, any the invention can be employed with as few as two lasers.

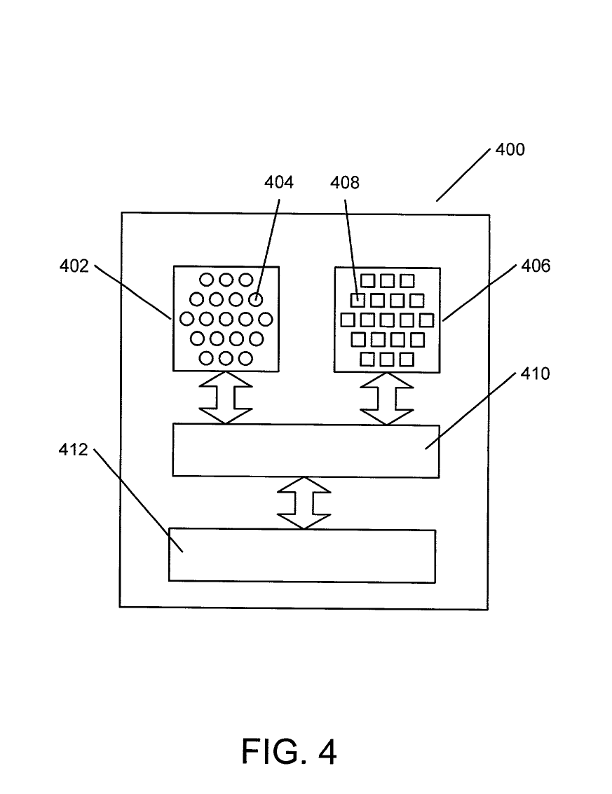

FIG. 4 is a simplified functional representation of a transceiver 400 suitable for configuring to operate according to the principles of the invention. The transceiver is made up of a transmitter portion 402 including some number of lasers, illustratively shown, for example, as a hexagonal arrangement of 19 similar individual lasers 404. The transceiver also includes a receiver portion 406 including some number of photodetectors 408 (interchangeably referred to herein as “detectors”), illustratively shown, for example, as a hexagonal arrangement of 19 detectors. It should be noted that, the number and arrangement of lasers 404 related to detectors 408 is the same in the example merely for simplicity.

Except as specified as required herein, the number of lasers need not, and in some cases will not, equal the number of detectors. For example, a particular transceiver may employ laser redundancy scheme such that two or more lasers share a fiber but there is only one detector per fiber. Or a transceiver may have some number of detectors, for example 72, but only 24 lasers because it is designed to be connected to two other transmitter devices with 24 lasers each.

The transceiver 400 also functionally includes control portion 410 including some form of a controller which may be, for example, a microprocessor, a special purpose processor, a state machine, or other programmable integrated circuit control circuitry. The transceiver 400 also optionally includes storage 412, in the form of static or dynamic random access memory (SRAM or DRAM), read only memory (ROM) or some combination thereof. The storage 412 is optionally used, for example, for configuration of the transceiver or maintaining a current or past record of transmitter, receiver and/or transceiver status, and is connected to the controller so that output of the controller can be received in the storage and output from the storage can be applied to or read by the controller.

Depending upon the particular transceiver, the lasers and detectors may physically share a common substrate, they may be interspersed among each other, and/or they may be separate parts of a chipset. In some cases, the transceiver may contain a programmable integrated circuit that incorporates one or more of the laser portion, receiver portion, control portion 410 and/or storage 412.

For simplicity, the invention will now be explained with reference to a number of different one- and two-dimensional arrays of devices bearing in mind that the particular number or geometric arrangement of the devices is irrelevant to understanding the invention. By employing the teachings herein, the invention can readily be implemented in an array where the arrangement of the devices are circular, oblong, triangular, hexagonal, any other geometric relationship, as well as an irregularly arranged array.

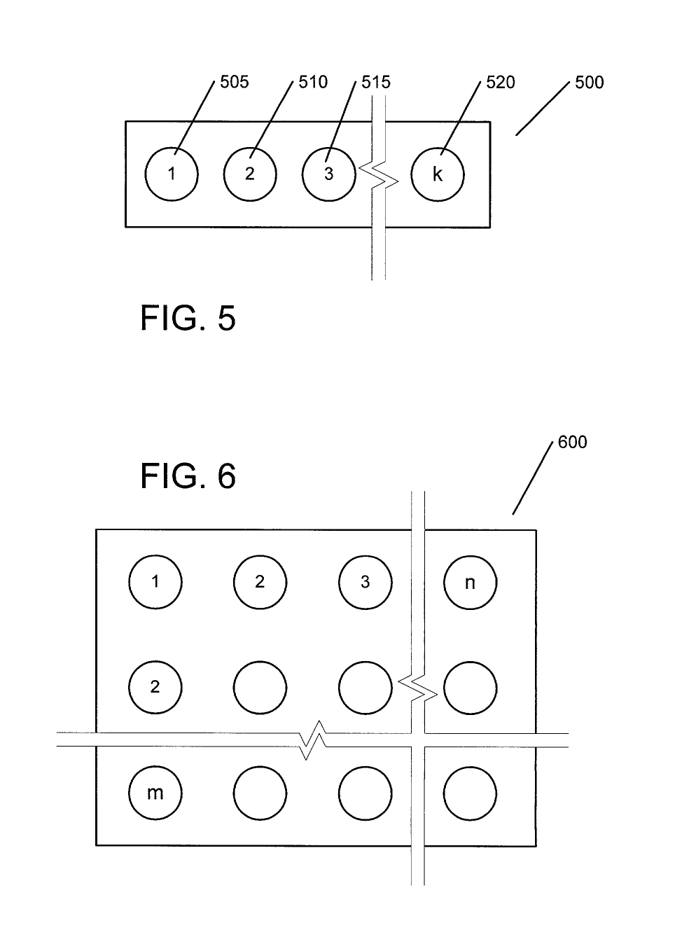

FIG. 5 is a simplified representation of a one-dimensional (i.e. linear) array 500 of optical devices 505, 510, 515, 520. The optical devices are part of a transceiver configured for operation in accordance with one variant of the invention. As shown the array is a 1 by k array of devices employing laser redundancy such that there are twice as many lasers as detectors (i.e. ⅔ of the devices are lasers and ⅓ are detectors). The lasers are paired, and each pair is coupled to one end of an individual fiber of a group of optical fibers. The fibers extend for some length and are connected at their other ends to one or more other transmitters, receivers or transceiver (also not shown).

For purposed of simplicity, explanation and understanding, it should be presumed for this variant that, in that particular example case that follows, the transceivers at both ends of the optical fibers are physically identical and that the lasers of one transceiver are coupled, via the fibers, to the detectors of the transceiver at the other end of the fibers. Moreover, it should be further presumed that the fibers are all contained in a single bundle or cable, such that it is likely that if the bundle or cable is breached anywhere along its length, at least the fiber for the eye safety channel will be cut.

In this variant, one channel is dedicated as an eye safety channel (i.e. one transmitting laser from the transceiver at one end (the designated eye safety or “e/s” transmitter) and one receiving detector of the transceiver at the other end (the designated e/s receiver)). A specified signal known to the e/s receiver is sent out of the e/s transmitter, for example, a slow speed clock embedded in a data signal or a specified data stream.

The controller in the transceiver with the e/s receiver monitors the e/s receiver for receipt of the specified signal. If, at any time, the signal is not received by the e/s receiver, the controller in that transceiver will presume that the link between the two transceivers is broken and will shut down the transmitting lasers in that same transceiver. Depending upon the particular implementation, detection of the known signal may be accomplished using conventional techniques such as, for example, looking for any activity or at least a specified number of transitions per given time period or window of time, matching data represented by the received signal against a stored expected data pattern, or applying any other of the numerous conventional techniques used for reliably determining that a valid or expected signal is being received.

In a second variant, both transceivers have dedicated eye safety channels (i.e. each has an e/s transmitter coupled through a fiber to an e/s receiver in the other). As a result, the operation is similar to the immediately preceding case except, if a controller's monitoring of an e/s receiver indicates that the signal is not being received it will shut down its lasers, including the e/s transmitter, thereby causing the other transceiver's e/s receiver to stop receiving a signal and triggering a shut down of its transmitters, called a “cascading” shutdown.

One advantage from this second variant is that all the transmitters in both transceivers are shut down if either eye safety channel is disrupted. Thus there is no eye safety risk, whereas in the first variant, the eye safety risk is only reduced because the transceiver containing the e/s transmitter will continue to transmit.

In a third variant, one transceiver has both an e/s transmitter and an e/s receiver and the other transceiver need not have any specific eye safety control, it need only be able to send some signal over a specified channel based upon receipt of a signal over another channel, either directly by, for example, “looping back” the received signal or indirectly, for example, by generating a new signal on a designated channel in response to receiving a signal on some specified channel. In operation, the e/s transmitter transmits a signal over a designated channel to the transceiver at the other end of the bundle or cable and that transceiver returns, over a specified return channel ultimately connected to the e/s receiver in the originating transceiver, a reply or looped back signal.

In the simplest case, the return signal is the same as the known signal originally sent, even if newly generated. In other cases, the return signal may be a different signal however, that different signal should be recognizable by controller in the transceiver having the e/s receiver as a, valid signal. In still other cases, the return signal can merely be in the form of some repeatedly transitioning signal. In those cases, the controller associated with the e/s receiver need not know what the signal is, it merely monitors for activity in the form of, for example, continuous transition activity or a minimum level of transitions within a specified window of time. Thus, in this variant, if the e/s receiver monitoring indicates a lack of activity, the transceiver housing the e/s transmitter and e/s receiver presumes the link is broken and shuts down its transmitters.

In still other cases, the signal sent between any e/s transmitter and e/s receiver need not be “known” at all to the other except, for example in the case of transitions per window of time, then some minimum level of activity must be specified to discriminate between an actual, valid signal and activity detected due to, for example, crosstalk or leakage from another fiber.

A further optional enhancement can be applied, in some cases, to the variants described herein, namely automatic turn-on. With automatic turn-on, the e/s receivers continue to be monitored even after the transmitters have been shut down. If the e/s receiver has indicated a fault and then, some time later, begins receiving a valid signal, the controller will automatically re-activate its transmitters. In this manner, if the connection is restored, for example by replacement of a disconnected connector, transmission can begin again without necessarily requiring external intervention or resetting of the transceiver.

An alternative optional enhancement, usable with some of the above variants, utilizes the capabilities of the controller to attempt to actively identify when the connection has been reestablished. To do so, the e/s receiver monitoring as done as described above. If an eye safety fault occurs (i.e. the monitoring of the e/s receiver results in a presumed fiber connection breach), all of the transmitters are de-activated except the e/s transmitter, which either continuously or periodically sends a signal (which may be the same as the normal signal or may be a different signal to indicate or differentiate normal operation from degraded operation) over the e/s channel despite the failure. Thus, when the connection is restored, the transmission will cause the e/s receiver at the other end of the fiber to begin detecting the e/s signal and the deactivated transmitters can be re-activated by the control portion.

Optionally, where a different signal is sent out post-failure, for example, a periodic, rather than continuous, eye safety signal, the controller can be configured to distinguish between the two so that, when a valid signal is detected at the e/s receiver, the post-failure signal will switch back to a normal signal.

In yet other variants, the data going to one or more transmitters is monitored. If a fault occurs that would send, for example, too many data “ones” to the lasers such that the average power from the lasers would exceed the eye safety limit, channels are shut down to bring the average power below the eye safety limit, even though no apparent or actual optical fiber breach has occurred.

In still other variants, particularly those where the transceivers on each end of the link are identical with respect to eye safety operation, the e/s transmitter and e/s receiver of each transceiver can share a single fiber, for example using an optical switch or “Y” configuration waveguide on each end. The e/s signals then alternate so that an e/s transmitter sends a signal of a specified duration and the e/s receiver at the other end of the link is monitored for receipt of the signal. If the e/s receiver in a transceiver receives a valid signal, that transceiver causes the e/s transmitter in it to send a signal back. That signal is monitored for at the other end of the link and, if it is received, the process repeats. As long as this “ping-ponging” of signals continues, the transmitters are kept active. If the ping-ponging ceases, both transceivers will shut down their transmitters due to a version of the cascade action described above.

Optionally, the e/s receivers can be kept active following a fault, and monitoring for reactivation can continue as described above except, since a single fiber is being used in a bidirectional manner, care must be taken to ensure that a failure condition does not persist because the e/s transmitters wind up synchronized and the transmitted signals cancel each other out in transit due to interference effects. This problem can be overcome by, for example, randomizing the timing of the transmission of the e/s signal during failure mode operation to ensure that at least some of the signals get through when the connection is restored, or by utilizing a different wavelength in one direction than is used in the other, or by using different polarizations for the two signals.

Advantageously, the above techniques all readily scale to larger arrays, for example, a two by three array of devices or larger. FIG. 6 is a simplified representation of an example two-dimensional array 600 of n by m optical devices. By using at least one receiver as an e/s receiver, eye safety can be accomplished irrespective of the number of transmitting devices.

All of the above variants employing the invention are particularly useful where the maximum aggregate power density from all the lasers of one transceiver are equal to, or less than, the maximum permissible exposure limit (which will vary depending upon the wavelength(s) of the lasers being used). However, as the size of the array increases, there comes a point where, due the minimum power density required to operate, the overall aggregate maximum power density cannot be decreased below the maximum permissible exposure level.

By way of example, if the maximum permissible exposure limit is 10 units, a two laser array can have a maximum power density of no more than 5 units per laser. A 5 laser array can have a maximum power density of no more than 2 units per laser. However, if minimum power density to operate was 1 unit per laser, the array could be no larger than 10 lasers without potentially exceeding the maximum permissible exposure level.

Advantageously, the principles of the invention can be employed in large arrays so that, despite the overall aggregate power being potentially large, the risk of exposure to laser radiation in excess of the maximum permissible exposure limit is minimal. This is accomplished through the use of two or more eye safety channels.

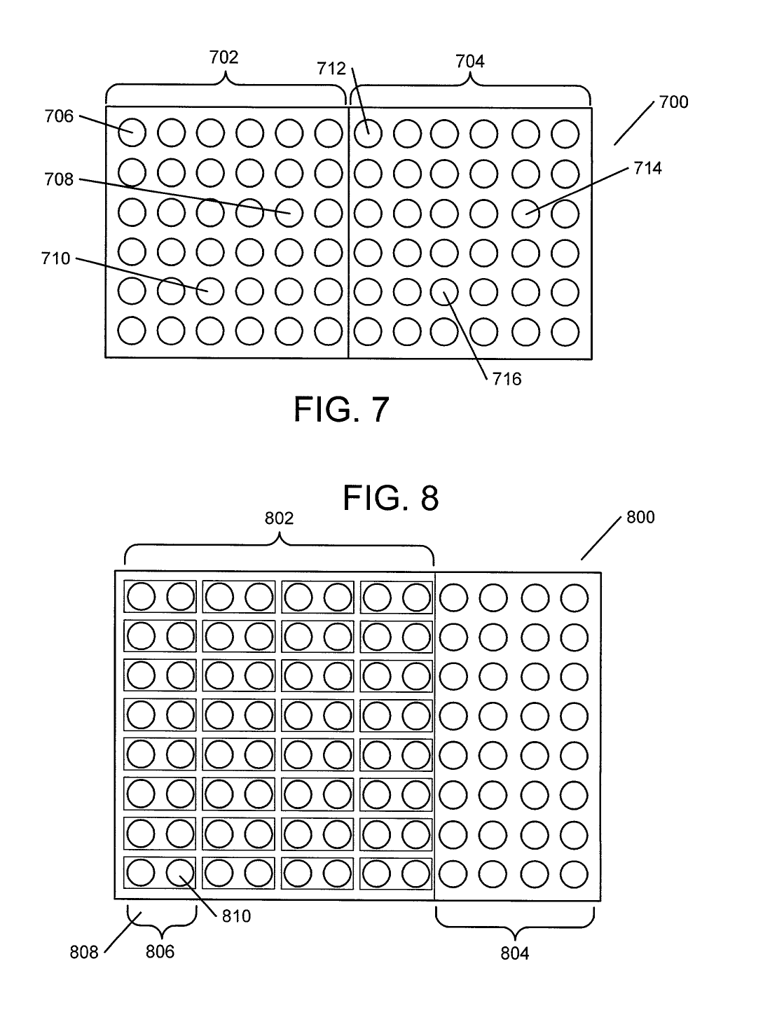

FIG. 7 is a 6×12 array 700 of optical devices in a transceiver employing the invention having a 6×6 array of transmitters 702 and a 6×6 array of receivers 704. As shown, there are three dedicated e/s transmitters 706, 708, 710 in the array 700 one e/s transmitter 706 being located in the upper left corner, a second 708 being the fifth from the left in the third row, and a third 710 being the third transmitter from the left in the fifth row. There are also three e/s receivers 712, 714, 716 located at the same positions as the transmitters in the receiver part 704 of the array 700.

The operation of this variant is similar to one of the variants described above except that by using three e/s transmitters and three e/s receivers, additional flexibility is provided. For example, because there are three e/s transmitters and three e/s receivers, there can be up to six separate e/s channels in use. This allows for partitioning of the devices, either implicitly through programming (i.e. logical partitioning) or directly via hard wiring (i.e. physical partitioning). In addition, an eye safety shutdown protocol that varies based upon, for example, the number of e/s signals that are detected, the number or type of lasers, or some other factor, can be employed.

Advantageously, by use of the storage in conjunction with a programmable controller, an implicit association between a particular receiver and one or more transmitter can be created. In this manner, particular transmitters can be controlled so that, if an e/s channel fault occurs, only the transmitters associated with that channel will be shut down.

For example, in one variant, each e/s receiver has a specified amount of associated storage locations into which addresses of transceivers can be stored.

To group or partition a device, the addresses of the transmitters that are to be part of a particular group or partition are stored in the locations corresponding to a particular receiver. If an e/s fault occurs, the controller will access the storage associated with the e/s receiver that detected the fault and shut down only those transmitters whose addresses are listed therein.

For example, assume the transceiver of FIG. 7 is connected, via 12-fiber bundles to one or more other transceivers and that the maximum power density of five transmitters, in aggregate, can exceed the maximum permissible exposure level, whereas four will not. By ensuring that there was one e/s device per bundle and associatively grouping the other 11 devices of the bundle with that e/s device, if an e/s fault is detected on an e/s line, the processor can merely shut down the transmitters that have been indicated as part of that bundle without affecting the operation of any of the other transmitters.

In variants employing an automatic turn-on option, the controller can further select or cycle through any or all of the transmitters on the list.

Moreover, if it is determined that only an e/s transmitter or e/s receiver is bad for some reason, repartitioning can be accomplished through programming with minimal downtime.

Still further, if the transceiver is programmable and all the receivers have the appropriate activity detection circuitry, then any transmitter and/or any receiver can advantageously designated an eye safety device through programming. The controller can then be used implement as simple or complex a protocol as is required in the particular application to, for example, shut down only the number of transmitters necessary to bring the potential aggregate power density of the remaining transmitters to or below the safety limit.

Moreover, if all the appropriate receivers have activity monitoring capability, faults can be isolated. The controller can implement a fault detection protocol, for example, that halts normal data transmission and cycles through transmission of fault detection patterns, using no more than the maximum number of devices that will be at or below the safety limit. If activity is detected by a transceiver on the other end of any line, that line can be presumed to be intact and continue being used. Once all the lines have been cycled through, all intact lines should be operational, and all lines exhibiting no activity can be presumed damaged or severed. Thus, a partial break in the bundle can be detected and its effect minimized without jeopardizing eye safety.

Partitioning is also advantageous for cases where, instead of all fibers from one module going to another module, fibers from a particular module may go to several modules. In this manner, through implicit (i.e. logical partitioning) shut down can be performed on a link basis.

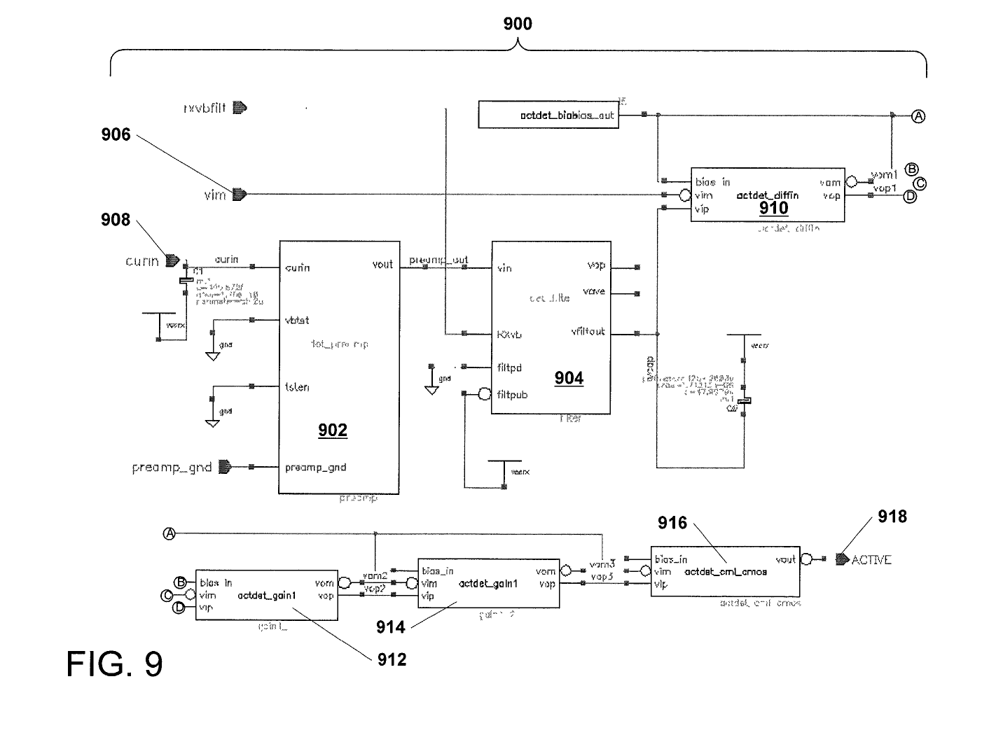

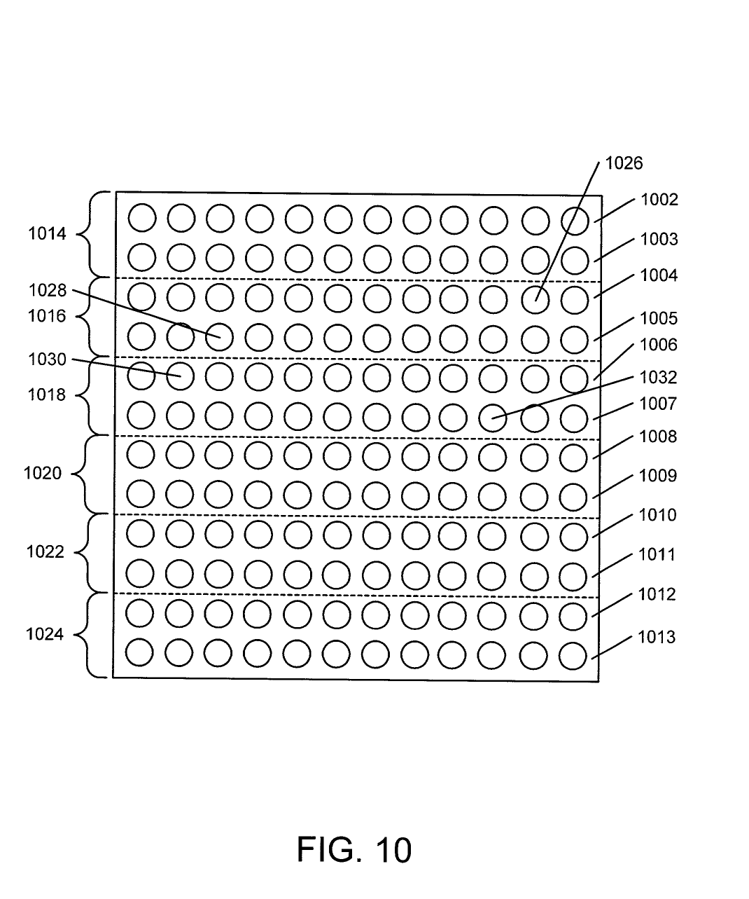

FIG. 8 shows a 96 device array 800 employing a further variant of the invention and having 64 transmitters 802 (paired as groups of two 806, with each pair 806 coupled to a common single fiber (not shown) for redundancy, and operating such that only one transmitter 808, 810 in the pair 806 is active at any time) and 32 receivers 804.

In this variant, no dedicated e/s channels are needed. Instead, the receivers are connected to activity detector circuitry which monitors for activity on active data channels. Thus, variants employing this technique need not sacrifice a data channel for eye safety.

The outputs of these detector circuits, indicate whether or not there is transitioning data on the channel, for example, based upon an amount of received transitions within a moving window of time. If no activity is detected for more than a specified window of time, a signal is sent out indicating that a potential fault condition exists. That signal is issued and, for example, detected by a processor or some other circuitry capable of causing a shut down of transmit circuitry (i.e. shutting down the lasers).

Depending upon the particular implementation, this can be accomplished in different ways.

In one example implementation, the activity detector outputs are hard wired within the transceiver to disable (shut down) inputs so that fault indicative inactivity on the receive side of the transceiver (whether it is a lack of activity for more than a particular amount of time or a lack of particular expected data) will shut down the transmit side, for example through use of a state machine.

In another example implementation, the activity and shut down signals are handled by a programmable integrated circuit that is part of the transceiver. Depending upon the particular implementation, the programmable integrated circuit may be in addition to the processor and/or storage or used in place thereof. The programmable integrated circuit receives the output of the activity detector circuitry, analyzes it to determine if any shut down is necessary and, if so, initiates shut down of transmitters. In addition, the programmable integrated circuit may also be used for configuration (e.g. grouping of devices, mapping of active devices, selecting which of the lasers in a pair will be used, etc.). Moreover, it may alternatively or additionally be used as a decision maker to decide, on a dynamic basis, what level of inactivity is necessary to initiate a shut down of some or all of the lasers.

In yet another example implementation, the activity signals are made available at a defined external interface to allow for the connection of custom decision making and/or control circuitry to control the lasers based upon received activity.

It should be understood that the above implementations are not necessarily mutually exclusive. For example, the external interface may be incorporated as a additional option in either of the other two examples, however, if this is done, some form of override should be provided to ensure that there is no contention between the external control and, for example, the state machine or programmable integrated circuit.

FIG. 9 shows one example of activity detector circuitry that can be used with variants described herein to protect against eye damage due to an optical fiber fault, such as a broken fiber or an opened connector. By way of example, the circuitry of FIG. 9 is for a 36 channel transceiver IC formatted with three rows of 12 VCSEL drivers (i.e. transmitters) and 3 rows of 12 photodetectors (i.e. receivers). The example transceiver uses a total of 6 activity detectors, two on each row. For purposes of this example, presume the activity detectors monitor each channel to determine if normal data is being received. If the optical link is broken, normal data will not be received and the activity detector will indicate a problem. The outputs from the two activity detectors per row are logically ORed together to generate three activity outputs signals.

These signals are used to turn off the row of VCSEL drivers when the receive activity detector indicates loss of signal. At least one VCSEL driver per row that has a corresponding receive channel with an activity detector are left on so that when normal data is restored the transmitters are turned back on.

As shown in the example activity detector circuitry 900 of FIG. 9, a comparison is made between voltage from the normal channel receive circuitry and a similar voltage seemingly generated by a dummy receiver in the activity detector. The det_preamp and det_filter blocks 902, 904 are collectively the dummy receiver of the activity detector circuitry 900. The voltage 906 from the normal receiver (vim) represents the amount of detector current received. The voltage from the dummy receiver 902, 904 in the activity detector represents a programmable current from an on-chip digital to analog converter (not shown). This current is input to the det_preamp circuit 902 through the curin input 908. The actdet_diffin block 910 is a comparator circuit used to determine when the voltage 906 from the normal channel is higher than the voltage from the dummy receiver 902, 904 in the activity detector.

Normal operation is indicated when the voltage 906 from the receiver is higher than the voltage from the dummy receive circuit 902, 904. This indicates that the receiver is receiving normal data.

When the receiver voltage 906 is lower than the dummy voltage, normal data has been interrupted and could indicate a fault (i.e. an eye safety incident). The actdet gain1 blocks 912, 914 are buffer amplifier circuits and the actdet_cml_cmos block 916 converts the cml signal to a cmos level signal. The output of the actdet_cml_cmos block 916 is an “ACTIVE” signal 918 that the controller monitors. When the receiver voltage 906 is higher than the dummy voltage, the ACTIVE signal 918 indicates that the channel(s) are active. If the receiver voltage 906 is lower than the dummy voltage the ACTIVE signal 918 indicates an inactive (i.e. potential fault) state. If the inactive state persists, for example, for more than a specified period of time or number of sequential cycles, a fault is indicated and the controller will shut down the appropriate transmitter(s) until the activity detector circuitry 900 indicates that the transmitters can be turned back on.

FIG. 10 is a further variant incorporating the invention using a combination of various variants discussed above. As shown, the array 1000 contains 144 devices arranged in twelve alternating rows of transmitters 1002, 1004, 1006, 1008, 1010, 1012 and receivers 1003, 1005, 1007, 1009, 1011, 1013. In addition, each row of transmitters is grouped with a row of receivers to form six transceiver partitions 1014, 1016, 1018, 1020, 1022, 1024. The grouping making up the partitions 1014, 1016, 1018, 1020, 1022, 1024 are hard wired into the transceiver but the transceiver is programmable on a partition 1014, 1016, 1018, 1020, 1022, 1024 basis so that each partition 1014, 1016, 1018, 1020, 1022, 1024 in the array 1000 can implement any of a number of different eye safety measures.

As shown the first partition 1014, has no dedicated eye safety channels. Instead, all the receivers 1003 in the first partition 1014 are monitored by activity detection circuitry such as shown in FIG. 9 which operates as described above.

The second partition 1016 has one dedicated e/s transmitter 1026 and e/s receiver 1028 and utilizes a “loop back” scheme whereby the output of the e/s transmitter 1026 is ultimately coupled to the e/s receiver 1028. The e/s transmitter 1026 transmits a continuous signal that is monitored for via the e/s receiver 1028. If the e/s signal is not detected on the receiver 1028, the transmitters 1004 in this partition 1016 are all shut down.

The third partition 1018 employs a similar scheme to that of the second partition 1016 except that it is designed to only connect to a similarly operating transceiver. In this manner, in the event of a fault, a cascading action will cause all transmitters 1006 in this partition 1018 and the transmitters in the corresponding transceiver(s) to shut down.

The fourth partition 1020 incorporates only a dedicated e/s receiver 1030 and associated pattern matching circuitry into which an expected e/s pattern can be programmed. As long as the received pattern matches the programmed pattern, the transmitters 1008 are enabled. If a fault occurs, the transmitters 1008 are shut down.

The fifth partition 1022 is fully programmable such that logical sub-partition(s) involving one or more of the twelve transmitters can be defined. In addition, any of the twelve transmitters 1010can, through programming, be designated as a dedicated e/s transmitter and all of the receivers 1011 include activity detection circuitry such that one or more of them can be grouped and/or defined, through programming, as e/s receivers.

The sixth partition 1024 is configured only for external control. The partition 1024 includes activity detector circuitry for all the transmitters 1012 to allow monitoring of activity on individual transmit channels and activity detector circuitry for all the receivers 1013 to similarly allow monitoring of activity on all receive channels. The outputs of the activity detector circuitry and transmitter control lines that can be used to shut down the lasers in this partition 1024 are brought out to a user accessible interface for connection to a control device provided by the user. In this manner, sub-partitioning or use of multiple e/s arrangements can be implemented.

It will now be further appreciated that, depending upon the particular implementation, further implementations and variants can be constructed by mixing and matching two or more of the different variants described herein in arrays of different sizes or by, for example, connecting two different types of variants described herein together at opposite ends of a fiber. For example, with respect to the variant of FIG. 10, if a similar pair of the above six-partition transceivers 1000 are at opposite ends of a common 24 fiber bundle, a fifth partition 1022 of one could be connected to any one of the first 1014, second 1016, third 1018, fourth 1020, or sixth 1024 partitions in the other in order to implement a different eye safety protocol depending upon the particular partition to which it is connected.

Finally, it should be understood that, by providing for programmability and providing an external interface, the operation of the transceiver can be dynamically controlled so that, as traffic or utilization conditions change, the operation of the transceivers can be changed.

Thus, while we have shown and described various examples employing the invention, it should be understood that the above description is only representative of illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments or other combinations of described portions may be available is not to be considered a disclaimer of those alternate embodiments. It can be appreciated that many of those undescribed embodiments are within the literal scope of the following claims, and others are equivalent.

What is claimed is:

1. In an optical transceiver having at least two photodetectors and at least two laser transmitters, a method of minimizing a risk of damage to human tissue, caused by an exposure to an amount of laser radiation in excess of a maximum permissible exposure level, the method comprising:
monitoring at least one of the photodetectors for receipt of an optical data signal;
determining, using a controller, if a received optical data signal satisfies at least one expected activity criterion; and,
if the received optical data signal does not satisfy the at least one expected activity criterion, determining that an eye safety fault condition exists and causing a shut down of at least one of the at least two laser transmitters.

2. The method of claim 1 wherein the determining further comprises comparing the optical data signal to an expected signal.

3. The method of claim 1 wherein the received optical data signal comprises a predetermined pattern.

4. The method if claim 3 wherein the received optical data signal comprises a clock.

5. The method of claim 1 wherein the monitoring is on a window of time basis.

6. The method of claim 5 wherein the determining occurs for a window of time.

7. The method of claim 1 wherein the causing the shut down further comprises:
triggering a cascading shut down.

8. The method of claim 1 further comprising:
determining that the eye safety fault condition has been corrected, and
automatically turning on at least one shut down transmitter.

9. The method of claim 8 further comprising:
monitoring a photodetector for post fault activity;
determining whether the post fault activity is valid; and
automatically turning on at least one shut down transmitter when the post fault activity is valid.

10. The method of claim 1 further comprising:
after the shut down, cycling through the shut down laser transmitters.

11. A method of providing for eye safety with an optical transceiver having multiple laser transmitters and optical receivers, the method comprising:
associating at least two of the multiple laser transmitters with an eye safety receiver channel;
monitoring the eye safety receiver channel for the presence of a received eye safety signal, and
if the eye safety signal ceases to be present, shutting down at least one of the at least two laser transmitters associated with the eye safety receiver channel.

12. The method of claim 11 wherein the associating further comprises logically grouping the at least two laser transmitters.

13. The method of claim 11 wherein the associating further comprises physically grouping the at least two laser transmitters.

14. The method of claim 11 further comprising:
partitioning the multiple lasers.

15. The method of claim 14 wherein the partitioning is based upon a maximum permissible exposure level.

16. The method of claim 11 further comprising:
comparing the received eye safety signal with an expected signal.

17. The method of claim 11 further comprising:
sending a known signal using one of the at least two laser transmitters.

18. The method of claim 17 wherein the received eye safety signal is the known signal.

19. A method of controlling emission of laser radiation from an optical transceiver having multiple transmit channels comprising:
transmitting data over a first transmit channel of the optical transceiver;
transmitting an eye safety signal over second transmit channel of the optical transceiver;
monitoring a dedicated receiver channel of the optical transceiver for an expected eye safety response signal and, if the monitoring indicates that the expected eye safety response signal is not being received, shutting down at least the first transmit channel.

20. The method of claim 19 further comprising:
partitioning the optical transceiver so that at least some of the multiple transmit channels are in a first partition and others of the multiple transmit channels are in a second partition.

21. The method of claim 20 wherein the method of claim 1 is only performed in the first partition.

22. An optical transceiver with multiple optical devices comprising:
a transmit channel;
a receiver channel;
an eye safety channel; and
a controller, coupled to the transmit channel and eye safety channel, and configured to receive information based upon a monitoring of the eye safety channel and shut down the transmit channel when the information indicates that an eye safety fault has occurred.

23. The transceiver of claim 22 further comprising:
storage, accessible by the controller, configured to store eye safety data.

24. The transceiver of claim 23 wherein the storage comprises stored eye safety data and the controller is further configured to access the storage and compare the received information to the stored eye safety data.

25. An optical communication system comprising:
a group of optical fibers, having first ends, second ends, and lengths in between;
a first transceiver coupled to a first end of a first optical fiber, the first transceiver having at least one laser transmitter and at least one eye safety receiver coupled to a first end of a second optical fiber; and
a second transceiver coupled to the second end of the first optical fiber, the first transceiver being controlled such that, when a laser transmitter is transmitting to the second transceiver over the first optical fiber and a specified condition, indicative of an eye safety fault, is detected by the at least one eye safety receiver, the first transceiver will turn off the laser transmitter.

26. The optical communication system of claim 25 wherein the second transceiver is coupled to a second end of the second optical fiber, and the second transceiver is configured to loop back a signal to the first transceiver via a second optical fiber.

27. The optical communication system of claim 25 wherein the specified condition is transitions within a window of time.

28. The optical communication system of claim 25 wherein the specified condition is a pattern mismatch.

29. The optical communication system of claim 25 wherein the specified condition is a loss of a clock signal embedded in a data signal.

30. The optical communication system of claim 25 further comprising:
an interface on the first transceiver through which the specified condition can be controlled.

31. An optical transceiver module, having an optical input and an optical output, comprising:
a transmission portion, comprising at least two transmitters,
a receiver portion, comprising at least two receivers, and
a controller, connected to the transmission portion and receiver portion, and constructed to
i) cause a specified data pattern to be sent by a first transmitter out of the optical output when a second of the at least two transmitters is active; and
ii) monitor at least one receiver to detect valid activity and, if the valid activity is not detected, render at least the second transmitter inactive.

32. The optical transceiver module of claim 31 wherein the transmission portion comprises at least two partitions.

33. The optical transceiver module of claim 32 wherein at least one of the at least two partitions are based upon a physical association.

34. The optical transceiver module of claim 32 wherein at least one of the at least two partitions are based upon a logical association.

35. The optical transceiver module of claim 31 wherein the receiver portion comprises at least two partitions.

36. The optical transceiver module of claim 35 wherein at least one of the at least two partitions are based upon a physical association.

37. The optical transceiver module of claim 35 wherein at least one of the at least two partitions are based upon a logical association.

38. The optical transceiver module of claim 31 wherein the controller is coupled to at least one of the transmitter portion or the receiver portion the via an external interface.

39. A method of providing for eye safety in an optical transceiver having transmitters and receivers, the method comprising:
transmitting a first eye safety signal, using one transmitter in the transceiver, when at least one other data transmitter is active;
monitoring an eye safety receiver, in the optical transceiver, for an eye safety fault condition;
determining, based upon a result of the monitoring, that the eye safety fault condition has occurred; and
deactivating the at least one other data transmitter in response to the determining.

40. An optical transceiver comprising:
at least two partitions, each of the at least two partitions comprising at least two optical devices; and
an activity monitoring unit, coupled to at least one optical device in at least one partition, the activity monitoring unit being constructed to monitor the at least one optical device for data activity and issue a signal when no data activity has occurred for a specified period of time.

41. The optical transceiver of claim 40 wherein the activity monitoring unit comprises activity monitoring circuitry.

42. The optical transceiver of claim 40 wherein the activity monitoring unit comprises a processor.

43. The optical transceiver of claim 40 wherein the activity monitoring unit comprises a state machine.

44. A method of performed in a optical communication system comprising at least two transmitters and at least two receivers, the method comprising:
determining that a optical fiber fault has occurred based upon a monitoring of one of the at least two receivers;
shutting down one of the at least two transmitters in response to the optical fiber fault;
detecting that the one of the at least two transmitters has been shut down; and
in response to the detecting, shutting down the other of the at least two transmitters.

45. A method performed in an optical communication system comprising multiple transmitters and multiple receivers, at least some of the multiple transmitters and multiple receivers being coupled to each other by optical fibers, the method comprising:
determining that an optical fiber fault has occurred on at least one of the optical fibers;
shutting down some of the transmitters based upon the determining; and
selectively turning on, and sending a signal out of, at least one of the shut down transmitters until a receiver receives the signal.

46. The method of claim 45 further comprising:
cycling through a turn on of, and data transmission from, other transmitters; and
monitoring for receipt of the data transmission at receivers coupled to the other transmitters.

47. The method of claim 46 further comprising:
leaving a cycled through transmitter on when a result of the monitoring indicates that that a no-fault condition exists for the optical fiber to which the cycled through transmitter is coupled.

48. The method of claim 46 further comprising:
shutting down a cycled through transmitter when a result of the monitoring indicates that that an optical fiber fault condition still exists for the optical fiber to which the cycled through transmitter is coupled.

49. In an optical transceiver system, a method comprising:
cycling through a turning on of shut down transmitters, the transmitters having been shut down due to a fault condition;
determining whether a no fault condition exists for each shut down transmitter; and
if the no fault condition exists for a particular transmitter, making the particular transmitter an active transmitter, and if the no fault condition does not exist, shutting down the particular transmitter.
